(19) United States
(12) Patent Application Publication
(10) Pub. No.: US 2025/0310903 A1
(43) Pub. Date: Oct. 2, 2025

(54) MEASUREMENT CONFIGURATION FOR ON-DEMAND SYNCHRONIZATION SIGNAL BLOCK AND TIME-DOMAIN SYNCHRONIZATION SIGNAL BLOCK ADAPTATION

(71) Applicant: QUALCOMM Incorporated, San Diego, CA (US)

(72) Inventors: Jae Ho RYU, San Diego, CA (US); Hung Dinh LY, San Diego, CA (US); Navid ABEDINI, Basking Ridge, NJ (US); Changhwan PARK, San Diego, CA (US); Hari SANKAR, San Diego, CA (US)

(21) Appl. No.: 18/618,198

(22) Filed: Mar. 27, 2024

(51) Int. Cl. H04W 56/00

(52) U.S. Cl. CPC H04W 56/001

(57) ABSTRACT

Methods, systems, and devices for wireless communications are described. A wireless communications system may support a measurement configuration for on-demand synchronization signal block (SSB) and time-domain SSB adaptation. A user equipment (UE) of the wireless communications system may receive, from a first network entity associated with a serving cell of the UE, one or more first control messages including a measurement timing configuration indicating a first set of multiple SSBs to be received by the UE from a neighbor cell via a first frequency layer. The measurement timing configuration may be associated with a capability of the neighbor cell to dynamically time-adapt the first set of multiple SSBs. The UE may monitor for the first set of multiple SSBs in accordance with the measurement timing configuration.

### FIELD OF TECHNOLOGY

The following relates to wireless communications, including measurement configuration for on-demand synchronization signal block (SSB) and time-domain SSB adaptation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless communications devices, such as UEs, may receive synchronization signal blocks (SSBs) to perform beam management, such as beam sweeping; measure a coverage level of a network entity; measure an interference level; or the like. For example, UEs may periodically receive and measure the SSBs and, based on measurements of the SSBs, determine one or more characteristics of a channel.

### SUMMARY

The described techniques relate to improved methods, systems, devices, and apparatuses that support measurement configuration for on-demand synchronization signal block (SSB) and time-domain SSB adaptation. For example, the described techniques provide for receiving, at a user equipment (UE) control messages configuring the UE with a measurement timing configuration. The measurement timing configuration indicate a set of SSBs to be received by the UE from a neighbor cell, such as a secondary cell, via a first frequency layer. Additionally, the measurement timing configuration may be associated with a capability of the neighbor cell to dynamically time-adapt SSBs. For example, the neighbor cell may support on-demand or time-adapted SSBs. The UE may monitor for the set of SSBs in accordance with the measurement timing configuration.

A method for wireless communications by a UE is described. The method may include receiving, from a first network entity associated with a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs and monitoring for the first set of multiple SSBs in accordance with the measurement timing configuration.

A UE for wireless communications is described. The UE may include one or more memories storing processor executable code, and one or more processors coupled with the one or more memories. The one or more processors may individually or collectively be operable to execute the code to cause the UE to receive, from a first network entity associated with a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs and monitor for the first set of multiple SSBs in accordance with the measurement timing configuration.

Another UE for wireless communications is described. The UE may include means for receiving, from a first network entity associated with a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs and means for monitoring for the first set of multiple SSBs in accordance with the measurement timing configuration.

A non-transitory computer-readable medium storing code for wireless communications is described. The code may include instructions executable by one or more processors to receive, from a first network entity associated with a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs and monitor for the first set of multiple SSBs in accordance with the measurement timing configuration.

Some examples of the method, UEs, and non-transitory computer-readable medium described herein may further include operations, features, means, or instructions for receiving one or more second control messages activating or deactivating the measurement timing configuration based on the first set of multiple SSBs being dynamically time-adapted, where monitoring for the first set of multiple SSBs may be in accordance with the activation or deactivation of the measurement timing configuration.

In some examples of the method, UEs, and non-transitory computer-readable medium described herein, the one or more second control messages include medium access control (MAC)-control element (CE) messages or downlink control information (DCI) messages.

Some examples of the method, UEs, and non-transitory computer-readable medium described herein may further include operations, features, means, or instructions for deactivating the measurement timing configuration based on a deactivation timer at the UE or on an expiration of a threshold duration of time.

In some examples of the method, UEs, and non-transitory computer-readable medium described herein, the one or more first control messages further include a second measurement timing configuration indicating a second set of multiple SSBs to be received by the UE via the first frequency layer.

In some examples of the method, UEs, and non-transitory computer-readable medium described herein, the second measurement timing configuration pertains to non-dynamically time-adapted SSBs and the second set of multiple SSBs may be the non-dynamically time-adapted SSBs.

Some examples of the method, UEs, and non-transitory computer-readable medium described herein may further include operations, features, means, or instructions for receiving a first SSB of the first set of multiple SSBs according to a first power level, a first beam width, or both and receiving a second SSB of the second set of multiple SSBs according to a second power level, a second beam width, or both.

In some examples of the method, UEs, and non-transitory computer-readable medium described herein, the measurement timing configuration includes a first periodicity associated with a first SSB type and a second periodicity associated with a second SSB type, the first SSB type including dynamically time-adapted SSB and the second SSB type including a non-dynamically time-adapted SSB.

Some examples of the method, UEs, and non-transitory computer-readable medium described herein may further include operations, features, means, or instructions for receiving one or more second control messages modifying a period of the first periodicity associated with the first SSB type, where the one or more second control messages include MAC-CE messages or DCI messages.

Some examples of the method, UEs, and non-transitory computer-readable medium described herein may further include operations, features, means, or instructions for performing a measurement procedure on the first set of multiple SSBs based on a measurement state of the UE, where the measurement procedure includes one of measuring the first set of multiple SSBs or refraining from measuring the first set of multiple SSBs.

In some examples of the method, UEs, and non-transitory computer-readable medium described herein, and the method, apparatuses, and non-transitory computer-readable medium may include further operations, features, means, or instructions for refraining from measuring the first set of multiple SSBs based on a radio resource management (RRM) measurement state at the UE.

In some examples of the method, UEs, and non-transitory computer-readable medium described herein, and the method, apparatuses, and non-transitory computer-readable medium may include further operations, features, means, or instructions for measuring the first set of multiple SSBs based on satisfaction of a threshold level of mobility, satisfaction of a threshold signal quality, or both.

In some examples of the method, UEs, and non-transitory computer-readable medium described herein, the monitoring may include operations, features, means, or instructions for monitoring for the first set of multiple SSBs from the set of multiple neighbor cells in accordance with the measurement timing configuration indicating the set of multiple neighbor cells.

A method for wireless communications by a network entity is described. The method may include transmitting, to a UE and via a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs, receiving a measurement report from the UE indicating one or more measurements based on the first set of multiple SSBs and the measurement timing configuration, and transmitting, to the UE, one or more second control messages associated with a mobility management of the UE based on the measurement report.

A network entity for wireless communications is described. The network entity may include one or more memories storing processor executable code, and one or more processors coupled with the one or more memories. The one or more processors may individually or collectively be operable to execute the code to cause the network entity to transmit, to a UE and via a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs, receive a measurement report from the UE indicating one or more measurements based on the first set of multiple SSBs and the measurement timing configuration, and transmit, to the UE, one or more second control messages associated with a mobility management of the UE based on the measurement report.

Another network entity for wireless communications is described. The network entity may include means for transmitting, to a UE and via a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs, means for receiving a measurement report from the UE indicating one or more measurements based on the first set of multiple SSBs and the measurement timing configuration, and means for transmitting, to the UE, one or more second control messages associated with a mobility management of the UE based on the measurement report.

A non-transitory computer-readable medium storing code for wireless communications is described. The code may include instructions executable by one or more processors to transmit, to a UE and via a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs, receive a measurement report from the UE indicating one or more measurements based on the first set of multiple SSBs and the measurement timing configuration, and transmit, to the UE, one or more second control messages associated with a mobility management of the UE based on the measurement report.

Some examples of the method, network entities, and non-transitory computer-readable medium described herein may further include operations, features, means, or instructions for receiving, via a backhaul link, an indication of an activation or a deactivation of dynamically time-adapted SSBs from a second network entity of the neighbor cell and transmitting, to the UE, one or more third control messages activating or deactivating the measurement timing configuration based on the indication of the activation or deactivation from the second network entity.

In some examples of the method, network entities, and non-transitory computer-readable medium described herein, the one or more third control messages include MAC-CE messages or DCI messages.

In some examples of the method, network entities, and non-transitory computer-readable medium described herein, the one or more first control messages further include a second measurement timing configuration indicating a second set of multiple SSBs to be received by the UE via the first frequency layer.

In some examples of the method, network entities, and non-transitory computer-readable medium described herein, the second measurement timing configuration pertains to non-dynamically time-adapted SSBs and the second set of multiple SSBs may be the non-dynamically time-adapted SSBs.

In some examples of the method, network entities, and non-transitory computer-readable medium described herein, the measurement timing configuration includes a first periodicity associated with a first SSB type and a second periodicity associated with a second SSB type, the second SSB type including a dynamically time-adapted SSB.

Some examples of the method, network entities, and non-transitory computer-readable medium described herein may further include operations, features, means, or instructions for transmitting one or more third control messages modifying a period of the first periodicity associated with the first SSB type, where the one or more third control messages include MAC-CE messages or DCI messages.

### BRIEF DESCRIPTION OF THE DRAWINGS

FIGS. 1 and 2 show examples of wireless communications systems that support measurement configuration for on-demand synchronization signal block (SSB) and time-domain SSB adaptation in accordance with one or more aspects of the present disclosure.

FIG. 3 shows an example of a timing diagram that supports measurement configuration for on-demand SSB and time-domain SSB adaptation in accordance with one or more aspects of the present disclosure.

FIG. 4 shows an example of a process flow that supports measurement configuration for on-demand SSB and time-domain SSB adaptation in accordance with one or more aspects of the present disclosure.

FIGS. 5 and 6 show block diagrams of devices that support measurement configuration for on-demand SSB and time-domain SSB adaptation in accordance with one or more aspects of the present disclosure.

FIG. 7 shows a block diagram of a communications manager that supports measurement configuration for on-demand SSB and time-domain SSB adaptation in accordance with one or more aspects of the present disclosure.

FIG. 8 shows a diagram of a system including a device that supports measurement configuration for on-demand SSB and time-domain SSB adaptation in accordance with one or more aspects of the present disclosure.

FIGS. 9 and 10 show block diagrams of devices that support measurement configuration for on-demand SSB and time-domain SSB adaptation in accordance with one or more aspects of the present disclosure.

FIG. 11 shows a block diagram of a communications manager that supports measurement configuration for on-demand SSB and time-domain SSB adaptation in accordance with one or more aspects of the present disclosure.

FIG. 12 shows a diagram of a system including a device that supports measurement configuration for on-demand SSB and time-domain SSB adaptation in accordance with one or more aspects of the present disclosure.

FIGS. 13 through 16 show flowcharts illustrating methods that support measurement configuration for on-demand SSB and time-domain SSB adaptation in accordance with one or more aspects of the present disclosure.

### DETAILED DESCRIPTION

A wireless communications system may support synchronization signal block (SSB)-based measurement according to a measurement timing configuration. For example, a network entity may indicate the measurement timing configuration (e.g., a synchronization signal (SS) or physical broadcast channel (PBCH) block measurement timing configuration (SMTC)) to a user equipment (UE) indicating a periodicity, a timing offset, or both associated with the SSB-based measurement. In some cases, the measurement timing configuration may be associated with a secondary cell of the UE, where the network entity is of a serving cell of the UE. For example, the network entity may indicate the measurement timing configuration associated with SSB-based radio resource management (RRM).

In some cases, the wireless communications system may also support adaptation of SSBs. For example, the network entity may adapt SSBs in a time domain (e.g., adapt a periodicity), such as activate or deactivate an SSB via a system information block (SIB) indication (e.g., SIB1) on a periodic basis. A UE may receive and decode the SIB (e.g., periodically), where some of the SIBs may activate or deactivate SSBs. However, a periodicity associated with the SIB may not support a threshold level of energy efficiency at the network entity, the UE, or both. For example, the network entity may activate or deactivate SSBs for network energy saving relatively slowly in cases in which the UE waits for and decodes the SIB. Additionally, or alternatively, the network entity may activate or deactivate (e.g., add or remove) SSBs dynamically. For example, a wireless communications system may support on-demand SSB operations, adaptation of SSBs in a time domain, or both. In some examples, dynamic adaptation of SSBs may be associated with a greater level of energy efficiency compared with adaptation of SSBs via SIBs. That is, UEs may receive information associated with SSB adaptation according to whether an SSB is to be activated or deactivated, rather than periodically, which may support network energy saving (NES). For example, the dynamic adaptation of SSBs may enable the one or more devices of the wireless communications system to enter a sleep state more quickly than via the adaptation via the SIB indication. However, the measurement timing configuration may not support dynamic adaptation of SSBs.

Measurement timing configurations may be adapted as described herein to support dynamic activation or deactivation in accordance with the on-demand SSBs, the adaptation of SSBs in the time domain, or both. Additionally, SSB-based RRM may be adapted based on the on-demand SSBs, the adaptation of SSBs in the time-domain, or both. The adapted measurement timing configurations may enable the network entity to activate or deactivate measurement timing configurations in accordance with on-demand or time-adapted SSB transmissions being enabled or disabled in adjacent cells, including the secondary cell of the UE. To support measurement configurations for on-demand SSBs and time-domain SSB adaptations, the network entity may transmit control messages to the UE configuring the UE with a measurement timing configuration associated with SSBs to be received by the UE via a neighboring cell (e.g., the secondary cell). For example, the network entity may indicate the measurement timing configuration to the UE based on the SSBs including on-demand SSBs or time-adapted SSBs. That is, the neighboring cell may be capable of activating on-demand SSBs in addition to or alternatively from always-on SSBs (e.g., non-time-adapted SSBs). In some examples, the network entity may indicate activation or deactivation of the on-demand SSBs or time-adapted SSBs to the UE via a dynamic indication, such as a medium access control (MAC)-control element (CE) or a downlink control information (DCI) message. For example, the network entity may obtain on-demand SSB or time-adapted SSB activation or deactivation information via a backhaul link from a second network entity of the neighboring cell and indicate the activation or deactivation information to the UE. After receiving the measurement timing configuration and, in some examples, after receiving the activation or deactivation information, the UE may monitor for the SSBs according to the measurement timing configuration.

Aspects of the disclosure are initially described in the context of wireless communications systems. Aspects of the disclosure are also described in the context of a timing diagram and process flow. Aspects of the disclosure are further illustrated by and described with reference to apparatus diagrams, system diagrams, and flowcharts that relate to measurement configuration for on-demand SSB and time-domain SSB adaptation.

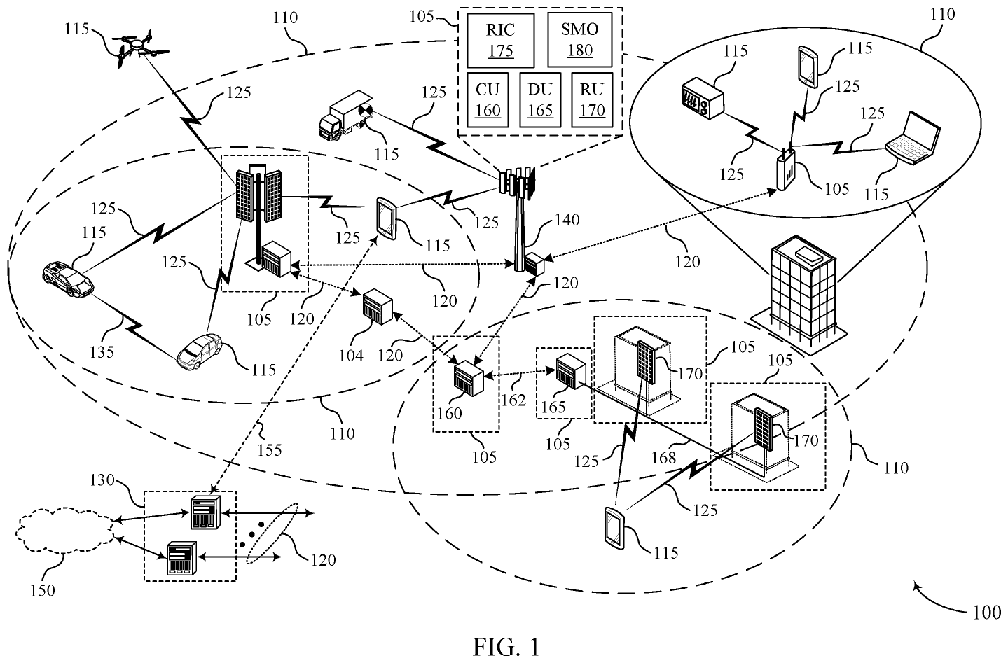

FIG. 1 shows an example of a wireless communications system 100 that supports measurement configuration for on-demand SSB and time-domain SSB adaptation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, the network entity 105 may transmit control messages to the UE 115 configuring the UE 115 with a measurement timing configuration associated with SSBs to be received by the UE 115 from a neighboring cell, such as from another network entity 105 associated with the neighboring cell. For example, the network entity 105 may indicate the measurement timing configuration to the UE 115 based on the SSBs including on-demand SSBs or time-adapted SSBs. In some examples, the network entity 105 may indicate activation or deactivation of the on-demand SSBs or time-adapted SSBs to the UE 115 via a dynamic indication. For example, the network entity 105 may obtain on-demand SSB or time-adapted SSB activation or deactivation information via a backhaul link, which may be an example of a communications link 125, from the other network entity 105 of the neighboring cell and indicate the activation or deactivation information to the UE 115. After receiving the measurement timing configuration and, in some examples, after receiving the activation or deactivation information, the UE 115 may monitor for the SSBs according to the measurement timing configuration.

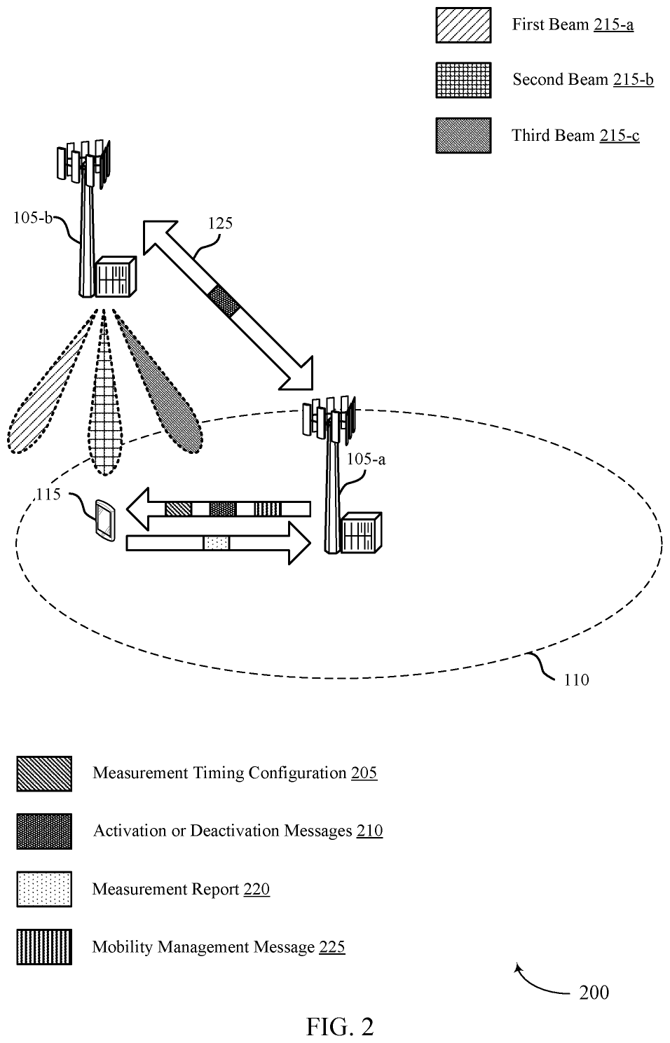

FIG. 2 shows an example of a wireless communications system 200 that supports measurement configuration for on-demand SSB and time-domain SSB adaptation in accordance with one or more aspects of the present disclosure. The wireless communications system 200 may implement or be implemented by various aspects of the wireless communications system 100. For example, the wireless communications system 200 may include a network entity 105-a, a network entity 105-b, a coverage area 110, a UE 115, and a communications link 125 which may be examples corresponding devices as described with reference to FIG. 1.

The wireless communications system 200 may support an on-demand SSB secondary cell operation for UEs in a connected mode configured with carrier aggregation, such as for intra-band or inter-band carrier aggregation. For example, the wireless communications system 200 may include a first cell supported by the network entity 105-a having the coverage area 110, where the first cell is a serving cell of the UE 115. Additionally, the wireless communications system 200 may include a second cell supported by the network entity 105-b, where the second cell is a secondary cell of the UE 115. The second cell may be a neighbor cell to the first cell. While one neighbor cell is illustrated and described with reference to FIG. 2, it may be understood that more than one cell may neighbor the serving cell of the UE 115. For example, the receipt of on-demand SSBs at the UE 115 from a secondary cell may occur for more than one secondary cell of the UE 115. Additionally, signaling illustrated and described between the network entity 105-a and the network entity 105-b may occur between the network entity 105-a and additional or different network entities of different neighboring cells to the first cell.

The network entity 105-a may configure the UE 115 with multiple measurement timing configurations associated with respective frequency layers (e.g., NR frequency layers). The measurement timing configuration may refer to an SMTC (e.g., SMTC1 or SMTC2) within a measurement configuration (e.g., MeasObjectNR). In other words, the measurement configuration may include one or more measurement timing configurations. In some examples, the network entity 105-a may configure the UE 115 with multiple measurement configurations, multiple measurement timing configurations, or both associated with the multiple frequency layers. That is, the network entity 105-a may transmit control messages to the UE 115 indicating a measurement timing configuration 205 (e.g., a first measurement timing configuration) associated with a first frequency layer, a second measurement timing configuration associated with a second frequency layer, and so on. Additionally, or alternatively, the network entity 105-a may transmit control messages indicating a first measurement configuration (e.g., a first MeasObjectNR) associated with the first frequency layer, a second measurement configuration (e.g., a second MeasObjectNR) associated with the second frequency layer, and so on. For example, the network entity 105-a may indicate a list of measurement configurations for respective frequency layers associated with transmission of on-demand SSBs from neighboring cells, such as from the network entity 105-b.

In some examples, the measurement timing configuration 205 may include multiple periodicities associated with different SSB types, such as always-on or on-demand SSBs. For example, the measurement timing configuration 205 may include a first periodicity associated with a first SSB type and a second periodicity associated with a second SSB type. In such examples, an offset associated with the first SSB type and the second SSB type may be the same.

Additionally, or alternatively, the network entity 105-a may indicate multiple measurement timing configurations associated with different SSB types, such as always-on or on-demand SSBs. For example, the measurement timing configuration 205 may be associated with the first SSB type while a second measurement timing configuration may be associated with the second SSB type. In such examples, the offset associated with the first SSB type and the second SSB type may be the same or different.

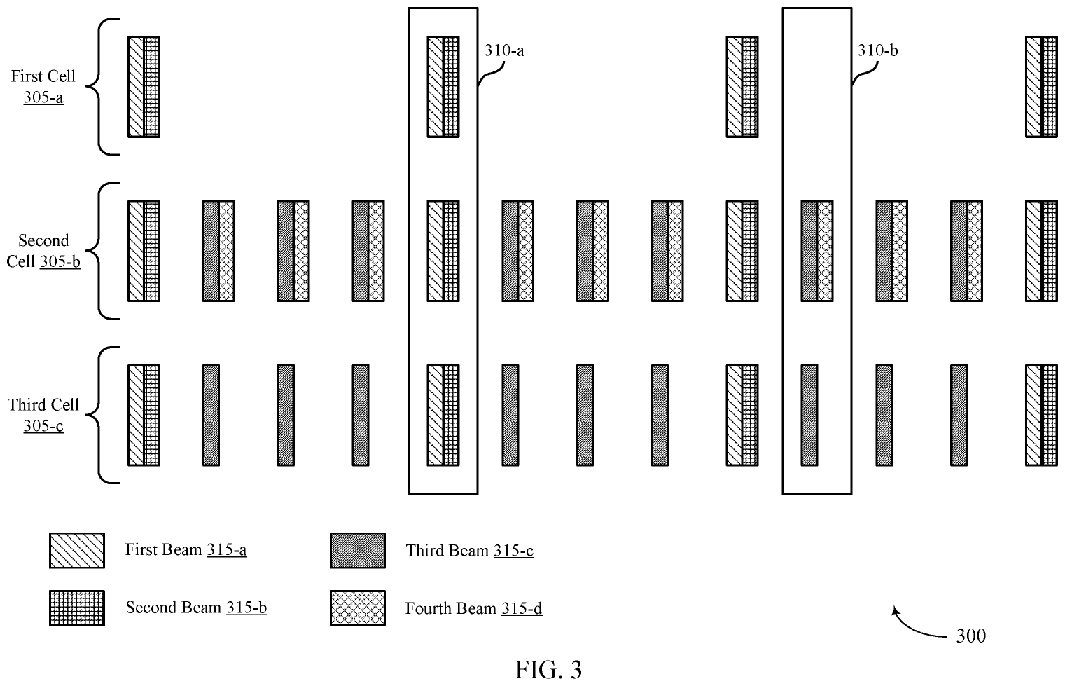

The first SSB type and the second SSB type may be described in greater detail elsewhere herein, including with reference to FIG. 3. The on-demand SSB transmissions may support secondary cell time and frequency synchronization, L1 and L3 measurements, and secondary cell activation, and, in some examples, may be used for one or more frequency ranges (e.g., FR1 and FR2) in a non-shared spectrum.

The network entity 105-a may include an indication of multiple cells in the measurement timing configuration 205, such as an indication of multiple PCIDs (e.g., PCI-List configuration). For example, the multiple cells in the measurement timing configuration 205 may be associated with a capability for time-adapted SSBs (e.g., on-demand SSBs). The UE 115 may determine one or more SSBs transmitted from a cell of one of the indicated cells to be on-demand SSBs while one or more SSBs transmitted from another cell not indicated in the multiple cells to be always-on SSBs. In other words, the UE 115 may assume that cells of the indication of multiple cells may transmit on-demand SSBs and/or perform measurements for always-on SSBs for cells not included in the indication of multiple cells.

The network entity 105-a may activate or deactivate the measurement timing configuration 205 at the UE 115. For example, the network entity 105-a may transmit control messages, such as activation or deactivation messages 210, activating or deactivating the measurement timing configuration. The activation or deactivation messages 210 may be a dynamic indication, such as a MAC-CE or DCI message via L1 or L2 signaling. The dynamic indication via L1 or L2 signaling may be more efficient than one or more other signaling types, such as via an RRC reconfiguration. In some examples, the network entity 105-a may transmit the activation or deactivation messages 210 based on a status of SSB transmission from neighboring cells. For example, the network entity 105-a may deactivate the measurement timing configuration at the UE 115 based on a deactivation of SSBs from a neighboring cell to conserve energy at the UE 115 (e.g., by avoiding unnecessary measurement, remaining in a wake-up state, etc.).

For example, the network entity 105-a may receive the activation or deactivation messages 210 from the network entity 105-b via the communication link 125, which may be a backhaul communication link. That is, the network entity 105-b may share (e.g., indicate), with the network entity 105-a, whether an on-demand SSBs are to be transmitted by the network entity 105-b to the UE 115. In some examples, the network entity 105-b may transmit on-demand SSBs based on a triggering condition. For example, the triggering condition may include a wake-up-signal from the UE 115, a cell activation or deactivation (e.g., on/off) indication via a backhaul link, secondary cell activation or deactivation signaling, or the like. The network entity 105-a may transmit the activation or deactivation messages 210 to the UE 115 based on the network entity 105-b indicating transmission of (e.g., or deactivation of transmission of) on-demand SSBs.

The UE 115 may monitor for SSBs according to the measurement timing configuration 205, the activation or deactivation messages 210, or both. For example, the UE 115 may monitor for SSBs during one or more monitoring occasions based on a periodicity of SSBs indicated by the measurement timing configuration 205. Additionally, or alternatively, the UE 115 may monitor for SSBs based on the measurement timing configuration 205 being activated via the activation or deactivation messages 210. Or, the UE 115 may refrain from monitoring for the SSBs based on the measurement timing configuration 205 being deactivated via the activation or deactivation messages.

In some examples, the UE 115 may check for a presence of (e.g., detect) an on-demand SSB transmission during an occasion of the measurement timing configuration 205. For example, the UE 115 may detect an on-demand SSB before performing a measurement procedure. That is, the UE 115 may perform a measurement procedure for an on-demand SSB based on detecting the on-demand SSB. The detection of on-demand SSBs may be described in further detail elsewhere herein, including with reference to FIG. 3.

The UE 115 may receive SSBs from the network entity 105-b via one or more beams, such as a first beam 215-a, a second beam 215-b, and a third beam 215-c. For example, each beam may be associated with a different SSB type, such as always-on SSBs or on-demand SSBs. The transmission of SSBs via different beams may be described in further detail elsewhere herein, including with reference to FIG. 3.

The UE 115 may measure the received SSBs from the network entity 105-b. For example, the UE 115 may perform a measurement procedure for on-demand SSBs from the network entity 105-b (e.g., from the secondary cell) based on a condition at the UE 115. As an example, the UE 115 may refrain from measuring the on-demand SSBs from the network entity 105-b based on being in a normal or relaxed RRM measurement state. In another example, the UE 115 may measure the on-demand SSBs from the network entity 105-b based on being in a high-mobility or poor signal quality state. In some examples, the UE 115 may determine the high-mobility or poor signal quality state independently (e.g., without signaling from the network entity 105-a or the network entity 105-b), based on parameters indicated by the network entity 105-a, or based on the network entity 105-a enabling or disabling RRM measurement using on-demand SSBs.

In some examples, the UE 115 may, as a part of the measurement procedure, compensate for a power offset when filtering reference signal received power (RSRP) or signal to interference noise ratio (SINR) measurements from always-on SSBs and on-demand SSBs. For example, the network entity 105-a may configure a power offset between always-on SSBs and on-demand SSBs. In other words, the UE 115 may perform the measurement procedure based on the power offset between a first SSB type (e.g., always-on SSBs) and a second SSB type (e.g., on-demand SSBs).

The UE 115 may transmit a measurement report 220 to the network entity 105 based on measuring the received SSBs from the network entity 105-b. For example, the network entity 105-a may receive the measurement report 220 from the UE 115 indicating one or more measurements based on the SSBs received at the UE 115 and the measurement timing configuration 205. In response to receiving the measurement report 220, the network entity 105-a may transmit a mobility management message 225 to the UE 115 based on the measurement report.

FIG. 3 shows an example of a timing diagram 300 that supports measurement configuration for on-demand SSB and time-domain SSB adaptation in accordance with one or more aspects of the present disclosure. The timing diagram 300 may implement or be implemented by various aspects of the wireless communications system 100, the wireless communications system 200, or both. For example, the timing diagram 300 may include a first cell 305-a, a second cell 305-b, and a third cell 305-c, which may be examples of secondary cells of a UE, such as the network entity 105-b of the secondary cell as described with reference to FIG. 2. Additionally, the timing diagram may include multiple SSBs associated with a first beam 315-a, a second beam 315-b, a third beam 315-c, or a fourth beam 315-d, which may be examples of first beam 215-a, the second beam 215-b, or the third beam 215-c as described with reference to FIG. 2.

A secondary cell of a UE, such as the secondary cell including the network entity 105-b as described with reference to FIG. 2, may transmit multiple types of SSBs to the UE. For example, the secondary cell may transmit legacy SSBs, sparse always-on SSBs, or on-demand SSBs to the UE. In some examples, the secondary cell may adapt one or more of the types of SSBs in a time-domain. That is, the secondary cell may adapt a periodicity of one or more of the types of SSBs.

Legacy SSB transmission may refer to SSBs with a first periodicity, such as a periodicity of 20 ms. The secondary cell may transmit the legacy SSBs with the first periodicity regardless of an activation or deactivation of the secondary cell. For example, while one or more other SSB types may be deactivated based on a deactivation of the secondary cell, the secondary cell may still transmit the legacy SSBs. In some examples, the secondary cell may transmit the legacy SSBs to a UE (e.g., a legacy UE) not having a capability to receive dynamically time-adapted SSBs (e.g., on-demand SSBs).

Sparse always-on SSBs may refer to SSBs with a second periodicity, such as a periodicity larger than 20 ms. The secondary cell may transmit the sparse always-on SSBs with the second periodicity regardless of the activation or deactivation of the secondary cell. For example, while the one or more other SSB types may be deactivated based on deactivation of the secondary cell, the secondary cell may still transmit the sparse always-on SSBs. Always-on SSBs may refer to legacy SSBs or sparse always-on SSBs. In some examples, the secondary cell may transmit the sparse always-on SSBs to the UE (e.g., the legacy UE) not having the capability to receive dynamically time-adapted SSBs (e.g., on-demand SSBs).

On-demand SSBs may refer to SSBs with a third periodicity. The secondary cell may transmit the on-demand SSBs with the third periodicity based on the activation or deactivation of the secondary cell. In some examples, the secondary cell may transmit the sparse always-on SSBs to the UE having the capability to receive dynamically time-adapted SSBs (e.g., on-demand SSBs). The secondary cell may transmit the on-demand SSBs during activation, after activation, or both. In other words, the secondary cell may transmit the on-demand SSBs during a transition from deactivation to activation or until the secondary cell is deactivated. In some examples, the secondary cell may transmit the on-demand SSBs during activation with the third periodicity and after activation with a fourth periodicity. For example, the secondary cell may transmit the on-demand SSBs with a same periodicity as the legacy SSB (e.g., the first periodicity) during activation and a same periodicity as the sparse always-on SSB (e.g., the second periodicity) after activation. In some other examples, the secondary cell may transmit the on-demand SSBs with the same periodicity as the legacy SSB (e.g., the first periodicity) during and after activation.

The secondary cell may transmit any combination of the one or more types of SSBs to the UE. For example, the secondary cell may transmit the on-demand SSBs in combination with the sparse always-on SSBs. As an example, the secondary cell may transmit the always-on SSBs in a deactivated state, and transmit the always-on SSBs and on-demand SSBs during activation, after activation, or both. In some other examples, the secondary cell may transmit the on-demand SSBs alone, such as without sparse always-on SSBs.

In the example of the timing diagram, the secondary cell may transmit SSBs of different SSB types to the UE via different beams. For example, the first cell 305-a may transmit sparse always-on SSBs to the UE via the first beam 315-a and the second beam 315-b. In another example, the second cell 305-b may transmit sparse always-on SSBs and on-demand SSBs via the first beam 315-a, the second beam 315-b, the third beam 315-c, and the fourth beam 315-d. The third cell 305-c may transmit sparse always-on SSBs and on-demand SSBs via the first beam 315-a, the second beam 315-b, and the third beam 315-c.

For example, the secondary cell may transmit SSBs to the UE via one or more beams. As an example, the first cell 305-a may transmit the always-on SSBs to the UE via two beams: the first beam 315-a and the second beam 315-b. Additionally, or alternatively, the secondary cell may transmit different types of SSBs via different beams. For example, the second cell 305-b may transmit always-on SSBs to the UE via the first beam 315-a and the second beam 315-b and transmit on-demand SSBs to the UE via the third beam 315-c and the fourth beam 315-d. As another example, the third cell 305-c may transmit always-on SSBs to the UE via the first beam 315-a and the second beam 315-b and transmit on-demand SSBs to the UE via the third beam 315-c.

In some examples, the secondary cell may transmit always on-SSBs and on-demand SSBs with different transmit powers, beam widths, or both. For example, the second cell 305-b may transmit the always-on SSBs via the first beam 315-a and the second beam 315-b with a first transmit power and a first beam width and transmit the on-demand SSBs via the third beam 315-c and the fourth beam 315-d with a second transmit power and a second beam width.

In some examples, an on-demand SSB occasion may overlap with an always-on SSB occasion. For example, during a first occasion 310-a, the on-demand SSB from the third beam 315-c and fourth beam 315-d for the second cell 305-b may overlap with the always-on SSB transmission from the first beam 315-a and the second beam 315-b. Additionally, during the first occasion, the on-demand SSB from the third beam 315-c for the third cell 305-c may overlap with the always-on SSB transmission from the first beam 315-a and the second beam 315-b. A UE receiving the SSB may monitor for, receive, or both the SSB during the first occasion 310-a as an always-on SSB based on the overlap. In other words, an on-demand SSB occasion overlapping with an always-on SSB occasion may be considered an always-on SSB occasion.

The UE may perform detection for on-demand SSBs. For example, during a second occasion 310-b, the UE may check for a presence of an on-demand SSB (e.g., based on a measurement timing configuration). In some examples, the UE may also perform detection for on-demand SSBs during the first occasion 310-a in which the on-demand SSBs overlap with the always-on SSBs from the second cell 305-b and the third cell 305-c. The UE may refrain from performing the detection for always-on SSBs. For example, during the first occasion 310-a, in which a UE has detected a prior instance of the always-on SSBs via the first beam 315-a and the second beam 315-b from one or more of the first cell 305-a, the second cell 305-b, or the third cell 305-c, the UE may refrain from detecting the always-on SSB. The UE may refrain from detecting based on determining that the always-on SSB will (e.g., always) be transmitted (e.g., as the always-on SSB is transmitted regardless of activation or deactivation of the secondary cell). However, for the on-demand SSBs, the UE may perform the detection to identify whether an on-demand SSB is transmitted in the occasion, as the on-demand SSB may not be transmitted, for example, based on a deactivation of the secondary cell. That is, the UE may perform the detection prior to measuring the on-demand SSB to ensure that a measurement is performed when an SSB is transmitted (e.g., to avoid measurement of an un-transmitted SSB).

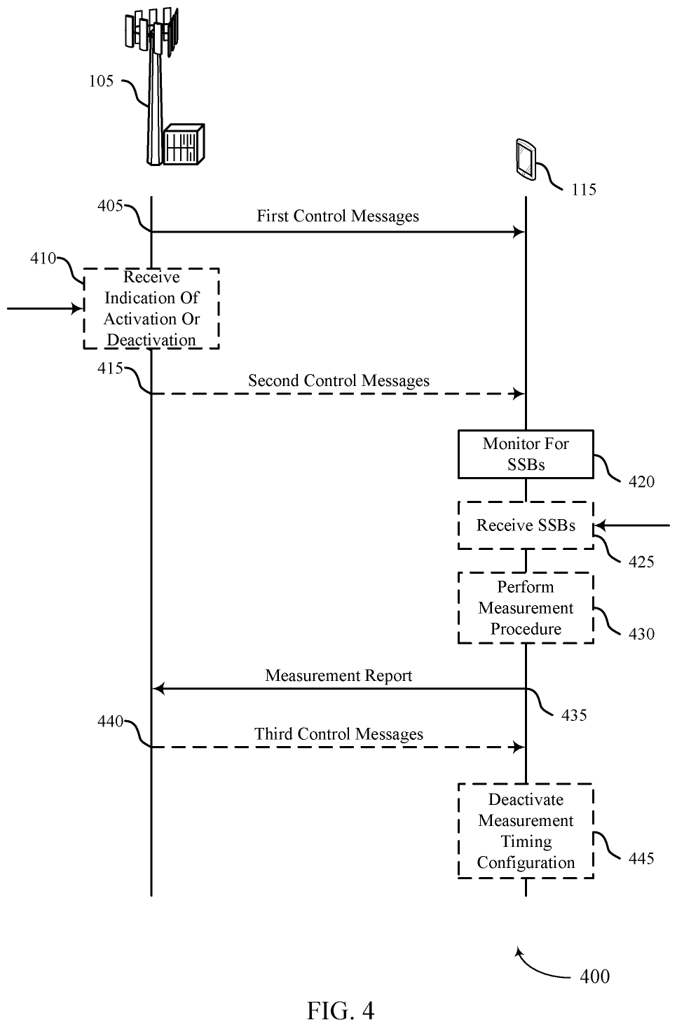

FIG. 4 shows an example of a process flow 400 that supports measurement configuration for on-demand SSB and time-domain SSB adaptation in accordance with one or more aspects of the present disclosure. In some examples, the process flow 400 may implement or be implemented by aspects of the wireless communications system 100 or the wireless communications system 200 as described with reference to FIG. 1 or FIG. 2. For example, the process flow 400 may be implemented by a network entity 105 and a UE 115, which may be examples of the network entity 105 and the UEs 115, respectively, as described with reference to FIG. 1 and FIG. 2. The process flow 400 may also implement or be implemented by aspects of timing diagram 300. Alternative examples of the following may be implemented, where some steps are performed in a different order than described or are not performed at all. In some cases, steps may include additional features not mentioned below, or further steps may be added.

At 405, the network entity 105 may transmit first control messages to the UE 115. The first control messages may include a measurement timing configuration, such as the measurement timing configuration 205 as described with reference to FIG. 2. For example, the UE 115 may receive, from the network entity 105 associated with a serving cell of the UE 115, first control messages including the measurement timing configuration indicating a first set of multiple SSBs to be received by the UE 115 from a neighbor cell via a first frequency layer. For example, the neighbor cell may be a cell having a coverage area or including a network entity, such as the coverage area 110 or the network entity 105 as described with reference to FIGS. 1 and 2. In some examples, the measurement timing configuration may be associated with a capability of the neighbor cell to dynamically time-adapt the first set of multiple SSBs. Additionally, or alternatively, the measurement timing configuration may be associated with a capability of the UE 115 to receive dynamic indications activating or deactivating the measurement timing configuration.

The first control messages may include a second measurement timing configuration indicating a second set of multiple SSBs to be received by the UE 115 via the first frequency layer. In other words, the network entity 105 may configure multiple (e.g., a list of) measurement timing configurations associated with frequency layers. In some examples, the second measurement timing configuration may pertain to non-dynamically time-adapted SSBs, and the second plurality of SSBs may be the non-dynamically time-adapted SSBs. For example, the network entity 105 may configure separate measurement timing configurations for sparse always-on SSBs and dense on-demand SSBs. In some examples, an offset associated with the always-on SSB may be the same as or different than the on-demand SSB.

Additionally, or alternatively, the measurement timing configuration may include a first periodicity associated with a first SSB type and a second periodicity associated with a second SSB type, where the first SSB type includes dynamically time-adapted SSB and the second SSB type includes a non-dynamically time-adapted SSB. In other words, the network entity 105 may configure the measurement timing configuration with different periodicities for sparse always-on SSBs and dense on-demand SSBs. In some examples, an offset associated with the always-on SSB may be the same as the on-demand SSB.

At 410, the network entity 105 may receive an indication of activation or deactivation of a measurement timing configuration. For example, the network entity 105 may receive, via a backhaul link, an indication of an activation or a deactivation of dynamically time-adapted SSBs from a second network entity of the neighbor cell. In some examples, neighboring cells may indicate on-demand SSB trigger states and indicate a transmission of on-demand SSBs. That is, the network entity 105 may activate the measurement timing configuration when the on-demand SSB trigger states are met or when the neighboring cells indicate the transmission of on-demand SSBs.

At 415, the network entity 105 may transmit second control messages to the UE 115. For example, the second control messages may activate or deactivate the measurement timing configuration based on the first set of multiple SSBs being dynamically time-adapted. The network entity 105 may transmit the second control messages based on receiving the indication of the activation or deactivation at 410 from the second network entity. In some examples, the second control messages may include MAC-CE messages or DCI messages. In other words, the network entity 105 may activate or deactivate the measurement timing configuration via a dynamic indication (e.g., L1 or L2 signaling) based on a status of on-demand SSB transmission from neighboring cells.

In some other examples, the second control messages may modify a period of the first periodicity associated with the first SSB type, where the one or more second control messages include MAC-CE messages or DCI messages.

At 420, the UE 115 may monitor for SSBs. For example, the UE 115 may monitor for the first set of multiple SSBs in accordance with the measurement timing configuration. Additionally, or alternatively, the UE 115 may monitor for the first plurality of SSBs is in accordance with the activation or deactivation of the measurement timing configuration received via the second control messages at 415.

In some examples, the UE 115 may monitor for the first set of multiple SSBs from a set of multiple neighbor cells in accordance with the measurement timing configuration indicating the set of multiple neighbor cells. That is, the first control messages indicating the measurement timing configuration may include an indication of the set of multiple neighbor cells. For example, the first control message may include a PCID list configuration for on-demand SSB, where the UE 115 may monitor for on-demand SSBs from the cells of the PCID list configuration. Alternatively, for cells not included in the PCID list configuration, the UE 115 may monitor for, measure, or both always-on SSBs.

At 425, the UE 115 may receive SSBs. For example, the UE 115 may receive SSBs from the neighbor cell based on the measurement timing configuration and the monitoring at 420. In some examples, the UE 115 may receive a first SSB of the first set of multiple SSBs according to a first power level, a first beam width, or both. Additionally, or alternatively, the UE 115 may receive a second SSB of the second plurality of SSBs according to a second power level, a second beam width, or both. As an example, the neighbor cell may transmit always-on SSBs and on-demand SSBs with different transmit powers, different beam widths, or both.

At 430, the UE 115 may perform a measurement procedure 430. For example, the UE 115 may perform a measurement procedure on the first set of multiple SSBs based on a measurement state of the UE 115, where the measurement procedure includes measuring the first set of multiple SSBs or refraining from measuring the first set of multiple SSBs. For example, the UE 115 may refrain from measuring the first set of multiple SSBs based on an RRM measurement state at the UE 115. Or, the UE 115 may measure the first set of multiple SSBs based on satisfaction of a threshold level of mobility, satisfaction of a threshold signal quality, or both. In other words, the UE 115 may not (e.g., may not be required to) measure an on-demand SSB when in a normal or relaxed RRM measurement state, but the UE may (e.g., may be required to) measure the on-demand SSB when in a high mobility or poor signal quality state.

In some examples, the UE 115 may, as a part of the measurement procedure, compensate for a power offset when filtering RSRP or SINR measurements from always-on SSBs and on-demand SSBs. For example, the network entity 105 may configure a power offset between always-on SSBs and on-demand SSBs. In other words, the UE 115 may perform the measurement procedure based on the power offset between a first SSB type (e.g., on-demand SSBs) and a second SSB type (e.g., always-on SSBs).

At 435, the UE 115 may transmit a measurement report to the network entity 105. For example, the network entity 105 may receive the measurement report from the UE 115 indicating one or more measurements based on the first set of multiple SSBs and the measurement timing configuration. In response to receiving the measurement report, at 440, the network entity 105 may transmit third control messages to the UE 115. For example, the network entity 105 may transmit the third control messages associated with a mobility management of the UE 115 based on the measurement report.

At 445, the UE 115 may deactivate a measurement timing configuration 445. For example, the UE 115 may deactivate the measurement timing configuration based on an indication of a deactivation of dynamically time-adapted SSBs from a second network entity of the neighbor cell, on a deactivation timer at the UE 115 or on an expiration of a threshold duration of time.

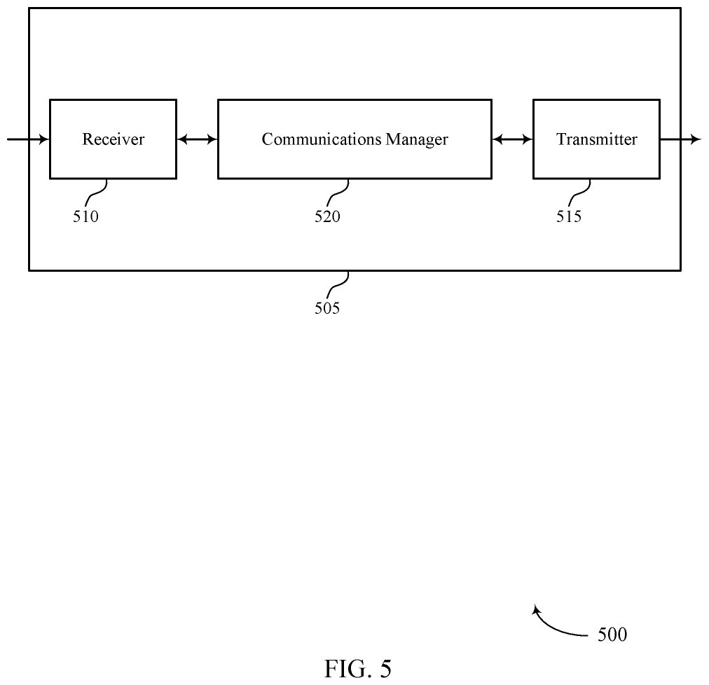

FIG. 5 shows a block diagram 500 of a device 505 that supports measurement configuration for on-demand SSB and time-domain SSB adaptation in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to measurement configuration for on-demand SSB and time-domain SSB adaptation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to measurement configuration for on-demand SSB and time-domain SSB adaptation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of measurement configuration for on-demand SSB and time-domain SSB adaptation as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, from a first network entity associated with a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The communications manager 520 is capable of, configured to, or operable to support a means for monitoring for the first set of multiple SSBs in accordance with the measurement timing configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources.

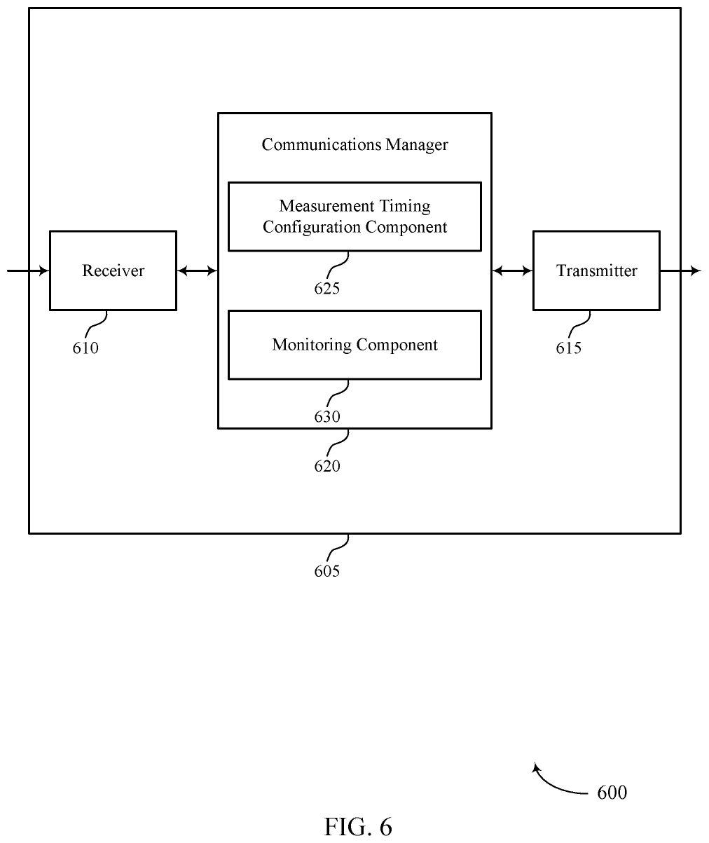

FIG. 6 shows a block diagram 600 of a device 605 that supports measurement configuration for on-demand SSB and time-domain SSB adaptation in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to measurement configuration for on-demand SSB and time-domain SSB adaptation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to measurement configuration for on-demand SSB and time-domain SSB adaptation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of measurement configuration for on-demand SSB and time-domain SSB adaptation as described herein. For example, the communications manager 620 may include a measurement timing configuration component 625 a monitoring component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The measurement timing configuration component 625 is capable of, configured to, or operable to support a means for receiving, from a first network entity associated with a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The monitoring component 630 is capable of, configured to, or operable to support a means for monitoring for the first set of multiple SSBs in accordance with the measurement timing configuration.

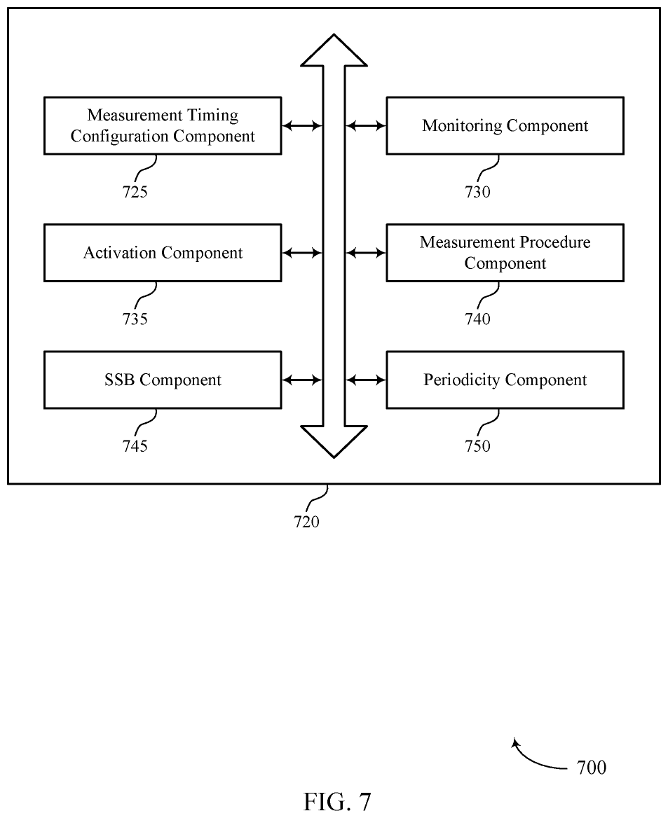

FIG. 7 shows a block diagram 700 of a communications manager 720 that supports measurement configuration for on-demand SSB and time-domain SSB adaptation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of measurement configuration for on-demand SSB and time-domain SSB adaptation as described herein. For example, the communications manager 720 may include a measurement timing configuration component 725, a monitoring component 730, an activation component 735, a measurement procedure component 740, an SSB component 745, a periodicity component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The measurement timing configuration component 725 is capable of, configured to, or operable to support a means for receiving, from a first network entity associated with a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The monitoring component 730 is capable of, configured to, or operable to support a means for monitoring for the first set of multiple SSBs in accordance with the measurement timing configuration.

In some examples, the activation component 735 is capable of, configured to, or operable to support a means for receiving one or more second control messages activating or deactivating the measurement timing configuration based on the first set of multiple SSBs being dynamically time-adapted, where monitoring for the first set of multiple SSBs is in accordance with the activation or deactivation of the measurement timing configuration.

In some examples, the one or more second control messages include MAC-CE messages or DCI messages.

In some examples, the activation component 735 is capable of, configured to, or operable to support a means for deactivating the measurement timing configuration based on an indication of a deactivation of dynamically time-adapted SSBs from a second network entity of the neighbor cell, on a deactivation timer at the UE or on an expiration of a threshold duration of time.

In some examples, the one or more first control messages further include a second measurement timing configuration indicating a second set of multiple SSBs to be received by the UE via the first frequency layer.

In some examples, the second measurement timing configuration pertains to non-dynamically time-adapted SSBs. In some examples, the second set of multiple SSBs are the non-dynamically time-adapted SSBs.

In some examples, the SSB component 745 is capable of, configured to, or operable to support a means for receiving a first SSB of the first set of multiple SSBs according to a first power level, a first beam width, or both. In some examples, the SSB component 745 is capable of, configured to, or operable to support a means for receiving a second SSB of the second set of multiple SSBs according to a second power level, a second beam width, or both.

In some examples, the measurement timing configuration includes a first periodicity associated with a first SSB type and a second periodicity associated with a second SSB type, the first SSB type including dynamically time-adapted SSB and the second SSB type including a non-dynamically time-adapted SSB.

In some examples, the periodicity component 750 is capable of, configured to, or operable to support a means for receiving one or more second control messages modifying a period of the first periodicity associated with the first SSB type, where the one or more second control messages include MAC-CE messages or DCI messages.

In some examples, the measurement procedure component 740 is capable of, configured to, or operable to support a means for performing a measurement procedure on the first set of multiple SSBs based on a measurement state of the UE, where the measurement procedure includes one of measuring the first set of multiple SSBs or refraining from measuring the first set of multiple SSBs.

In some examples, to support the measurement procedure on the first set of multiple SSBs, the measurement procedure component 740 is capable of, configured to, or operable to support a means for refraining from measuring the first set of multiple SSBs based on a RRM measurement state at the UE.

In some examples, to support the measurement procedure on the first set of multiple SSBs, the measurement procedure component 740 is capable of, configured to, or operable to support a means for measuring the first set of multiple SSBs based on satisfaction of a threshold level of mobility, satisfaction of a threshold signal quality, or both.

In some examples, to support monitoring, the monitoring component 730 is capable of, configured to, or operable to support a means for monitoring for the first set of multiple SSBs from the set of multiple neighbor cells in accordance with the measurement timing configuration indicating the set of multiple neighbor cells.

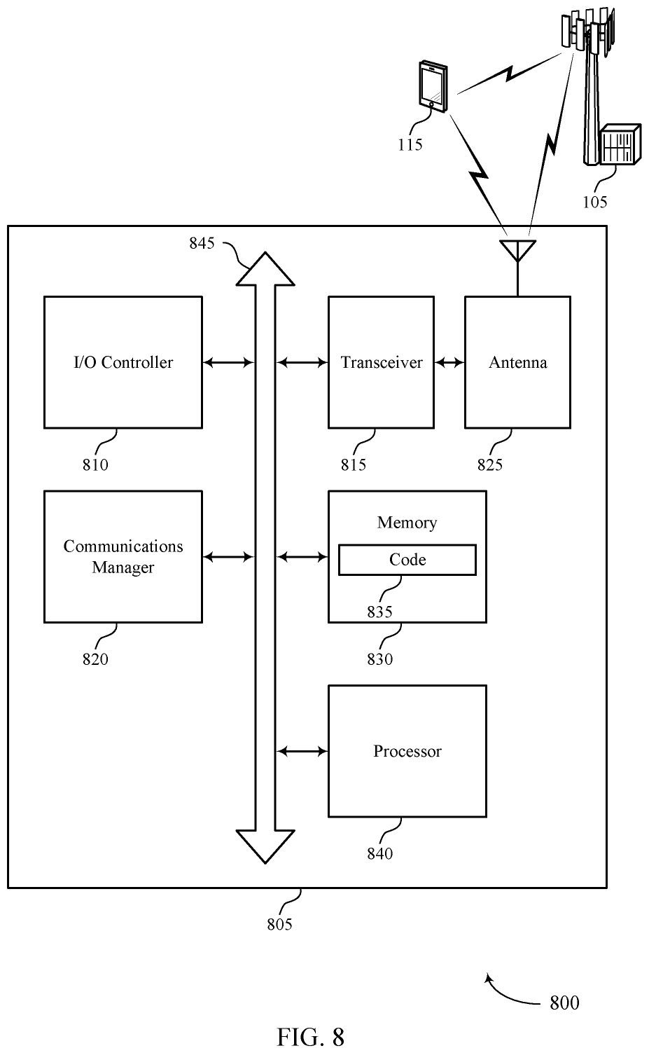

FIG. 8 shows a diagram of a system 800 including a device 805 that supports measurement configuration for on-demand SSB and time-domain SSB adaptation in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller.

In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting measurement configuration for on-demand SSB and time-domain SSB adaptation). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, from a first network entity associated with a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The communications manager 820 is capable of, configured to, or operable to support a means for monitoring for the first set of multiple SSBs in accordance with the measurement timing configuration.

By including or configuring the communications manager 820 in accordance with examples as described herein, the device 805 may support techniques for reduced power consumption and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of measurement configuration for on-demand SSB and time-domain SSB adaptation as described herein, or the at least one processor 840 and the at least one memory 830 may be otherwise configured to, individually or collectively, perform or support such operations.

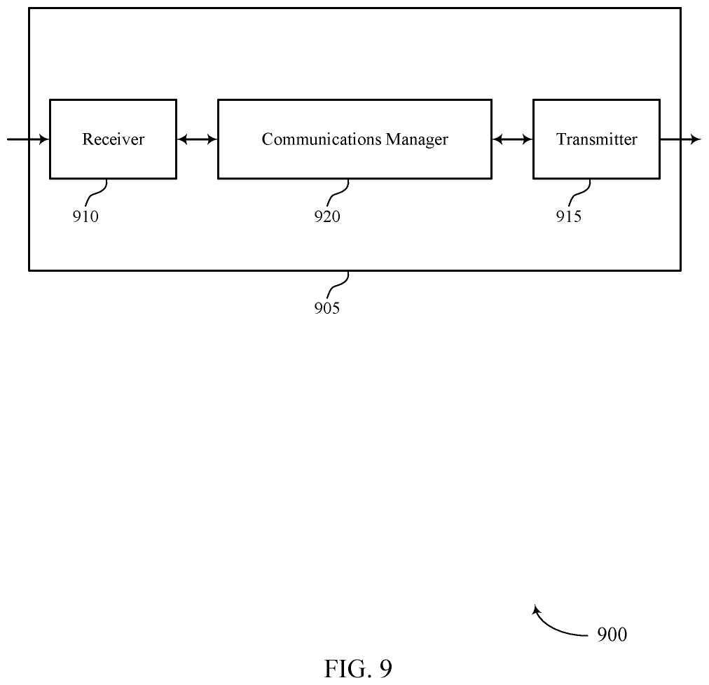

FIG. 9 shows a block diagram 900 of a device 905 that supports measurement configuration for on-demand SSB and time-domain SSB adaptation in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of measurement configuration for on-demand SSB and time-domain SSB adaptation as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a UE and via a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The communications manager 920 is capable of, configured to, or operable to support a means for receiving a measurement report from the UE indicating one or more measurements based on the first set of multiple SSBs and the measurement timing configuration. The communications manager 920 is capable of, configured to, or operable to support a means for transmitting, to the UE, one or more second control messages associated with a mobility management of the UE based on the measurement report.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption and more efficient utilization of communication resources.

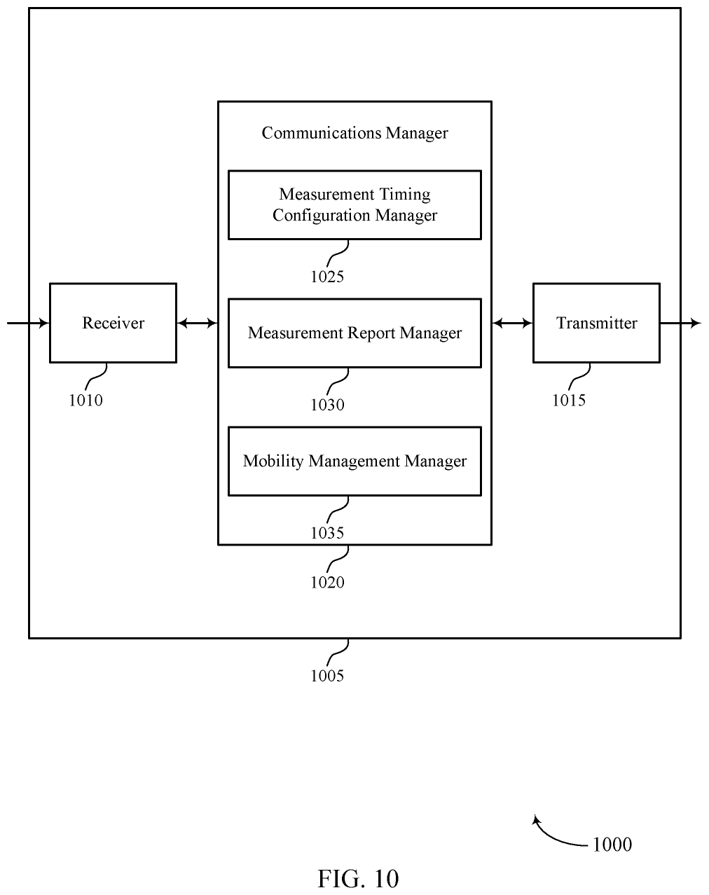

FIG. 10 shows a block diagram 1000 of a device 1005 that supports measurement configuration for on-demand SSB and time-domain SSB adaptation in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of measurement configuration for on-demand SSB and time-domain SSB adaptation as described herein. For example, the communications manager 1020 may include a measurement timing configuration manager 1025, a measurement report manager 1030, a mobility management manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The measurement timing configuration manager 1025 is capable of, configured to, or operable to support a means for transmitting, to a UE and via a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The measurement report manager 1030 is capable of, configured to, or operable to support a means for receiving a measurement report from the UE indicating one or more measurements based on the first set of multiple SSBs and the measurement timing configuration. The mobility management manager 1035 is capable of, configured to, or operable to support a means for transmitting, to the UE, one or more second control messages associated with a mobility management of the UE based on the measurement report.

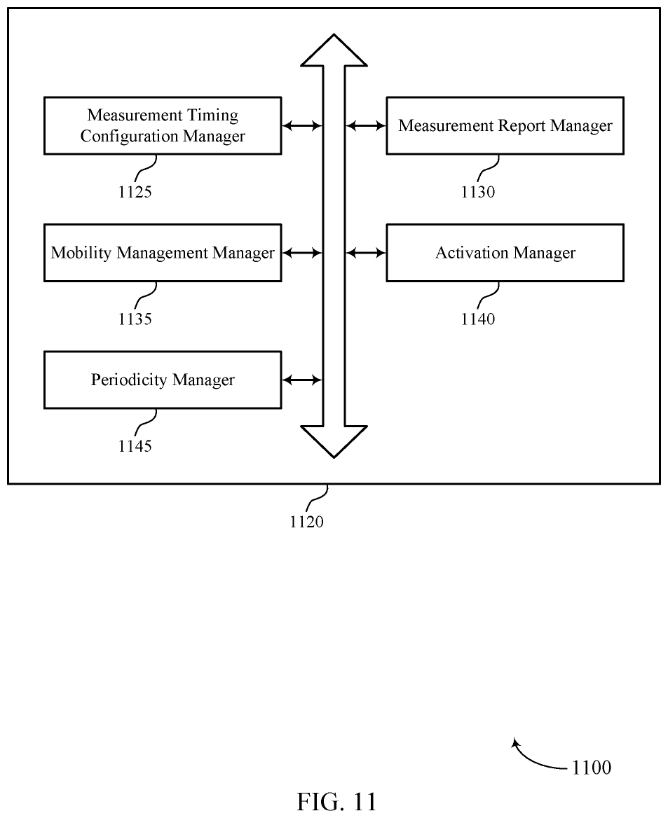

FIG. 11 shows a block diagram 1100 of a communications manager 1120 that supports measurement configuration for on-demand SSB and time-domain SSB adaptation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of measurement configuration for on-demand SSB and time-domain SSB adaptation as described herein. For example, the communications manager 1120 may include a measurement timing configuration manager 1125, a measurement report manager 1130, a mobility management manager 1135, an activation manager 1140, a periodicity manager 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The measurement timing configuration manager 1125 is capable of, configured to, or operable to support a means for transmitting, to a UE and via a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The measurement report manager 1130 is capable of, configured to, or operable to support a means for receiving a measurement report from the UE indicating one or more measurements based on the first set of multiple SSBs and the measurement timing configuration. The mobility management manager 1135 is capable of, configured to, or operable to support a means for transmitting, to the UE, one or more second control messages associated with a mobility management of the UE based on the measurement report.

In some examples, the activation manager 1140 is capable of, configured to, or operable to support a means for receiving, via a backhaul link, an indication of an activation or a deactivation of dynamically time-adapted SSBs from a second network entity of the neighbor cell. In some examples, the activation manager 1140 is capable of, configured to, or operable to support a means for transmitting, to the UE, one or more third control messages activating or deactivating the measurement timing configuration based on the indication of the activation or deactivation from the second network entity.

In some examples, the one or more third control messages include MAC-CE messages or DCI messages.

In some examples, the one or more first control messages further include a second measurement timing configuration indicating a second set of multiple SSBs to be received by the UE via the first frequency layer.

In some examples, the second measurement timing configuration pertains to non-dynamically time-adapted SSBs. In some examples, the second set of multiple SSBs are the non-dynamically time-adapted SSBs.

In some examples, the measurement timing configuration includes a first periodicity associated with a first SSB type and a second periodicity associated with a second SSB type, the second SSB type including a dynamically time-adapted SSB.

In some examples, the periodicity manager 1145 is capable of, configured to, or operable to support a means for transmitting one or more third control messages modifying a period of the first periodicity associated with the first SSB type, where the one or more third control messages include MAC-CE messages or DCI messages.

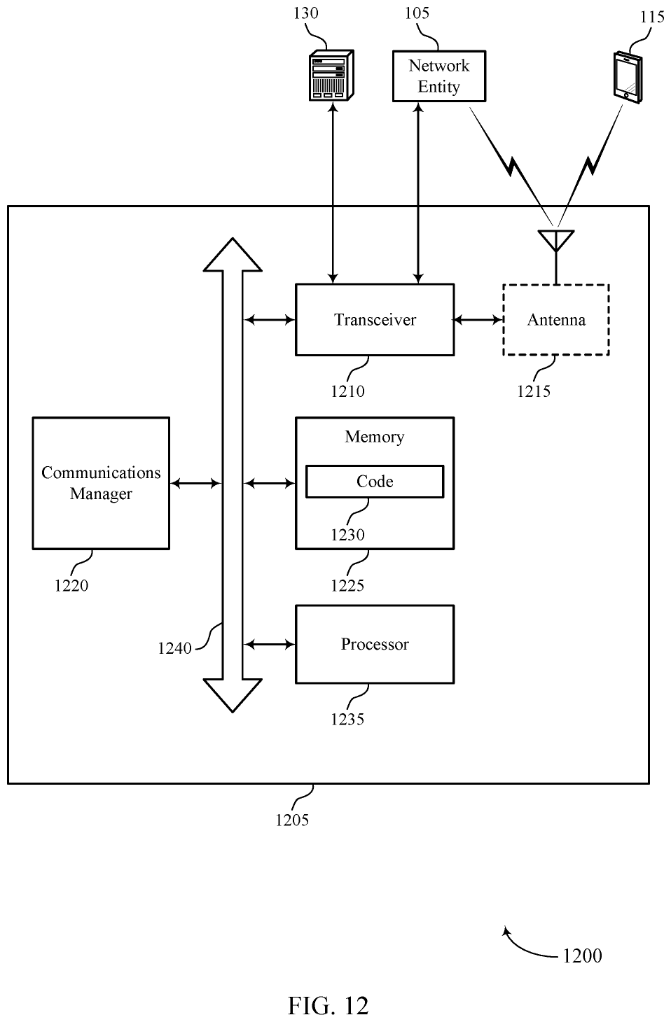

FIG. 12 shows a diagram of a system 1200 including a device 1205 that supports measurement configuration for on-demand SSB and time-domain SSB adaptation in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting measurement configuration for on-demand SSB and time-domain SSB adaptation). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting, to a UE and via a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The communications manager 1220 is capable of, configured to, or operable to support a means for receiving a measurement report from the UE indicating one or more measurements based on the first set of multiple SSBs and the measurement timing configuration. The communications manager 1220 is capable of, configured to, or operable to support a means for transmitting, to the UE, one or more second control messages associated with a mobility management of the UE based on the measurement report.

By including or configuring the communications manager 1220 in accordance with examples as described herein, the device 1205 may support techniques for reduced power consumption and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of measurement configuration for on-demand SSB and time-domain SSB adaptation as described herein, or the at least one processor 1235 and the at least one memory 1225 may be otherwise configured to, individually or collectively, perform or support such operations.

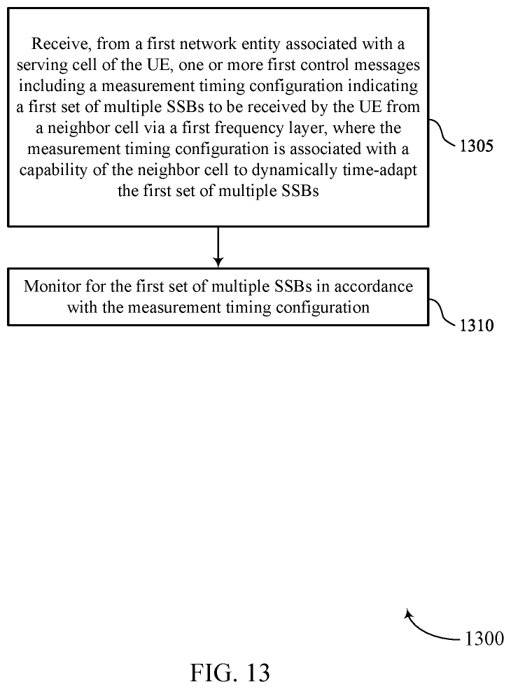

FIG. 13 shows a flowchart illustrating a method 1300 that supports measurement configuration for on-demand SSB and time-domain SSB adaptation in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a first network entity associated with a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The operations of 1305 may be performed in accordance with examples as disclosed herein. In some examples, aspects of the operations of 1305 may be performed by a measurement timing configuration component 725 as described with reference to FIG. 7.

At 1310, the method may include monitoring for the first set of multiple SSBs in accordance with the measurement timing configuration. The operations of 1310 may be performed in accordance with examples as disclosed herein. In some examples, aspects of the operations of 1310 may be performed by a monitoring component 730 as described with reference to FIG. 7.

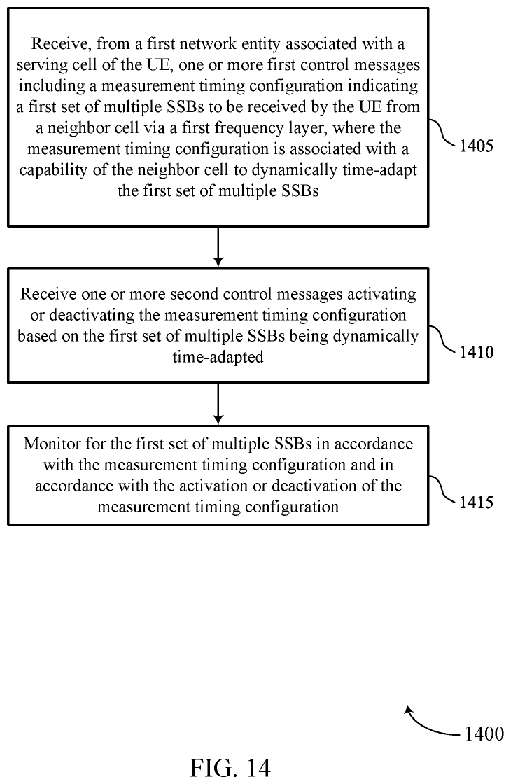

FIG. 14 shows a flowchart illustrating a method 1400 that supports measurement configuration for on-demand SSB and time-domain SSB adaptation in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a first network entity associated with a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The operations of 1405 may be performed in accordance with examples as disclosed herein. In some examples, aspects of the operations of 1405 may be performed by a measurement timing configuration component 725 as described with reference to FIG. 7.

At 1410, the method may include receiving one or more second control messages activating or deactivating the measurement timing configuration based on the first set of multiple SSBs being dynamically time-adapted, where monitoring for the first set of multiple SSBs is in accordance with the activation or deactivation of the measurement timing configuration. The operations of 1410 may be performed in accordance with examples as disclosed herein. In some examples, aspects of the operations of 1410 may be performed by an activation component 735 as described with reference to FIG. 7.

At 1415, the method may include monitoring for the first set of multiple SSBs in accordance with the measurement timing configuration. The operations of 1415 may be performed in accordance with examples as disclosed herein. In some examples, aspects of the operations of 1415 may be performed by a monitoring component 730 as described with reference to FIG. 7.

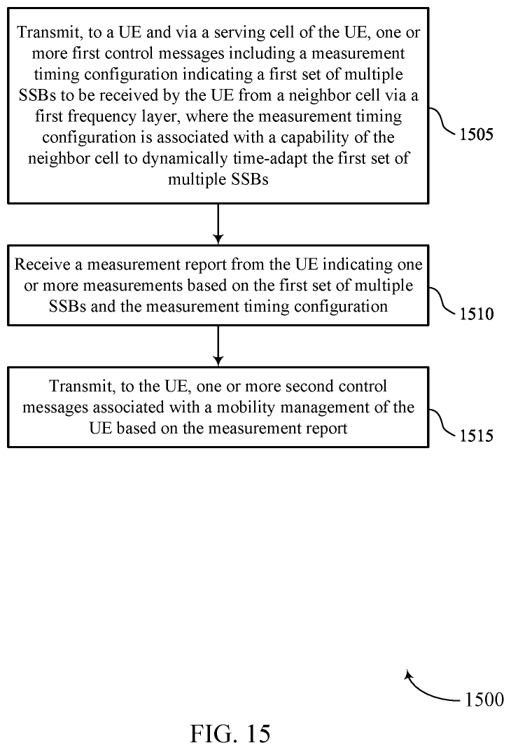

FIG. 15 shows a flowchart illustrating a method 1500 that supports measurement configuration for on-demand SSB and time-domain SSB adaptation in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE and via a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The operations of 1505 may be performed in accordance with examples as disclosed herein. In some examples, aspects of the operations of 1505 may be performed by a measurement timing configuration manager 1125 as described with reference to FIG. 11.

At 1510, the method may include receiving a measurement report from the UE indicating one or more measurements based on the first set of multiple SSBs and the measurement timing configuration. The operations of 1510 may be performed in accordance with examples as disclosed herein. In some examples, aspects of the operations of 1510 may be performed by a measurement report manager 1130 as described with reference to FIG. 11.

At 1515, the method may include transmitting, to the UE, one or more second control messages associated with a mobility management of the UE based on the measurement report. The operations of 1515 may be performed in accordance with examples as disclosed herein. In some examples, aspects of the operations of 1515 may be performed by a mobility management manager 1135 as described with reference to FIG. 11.

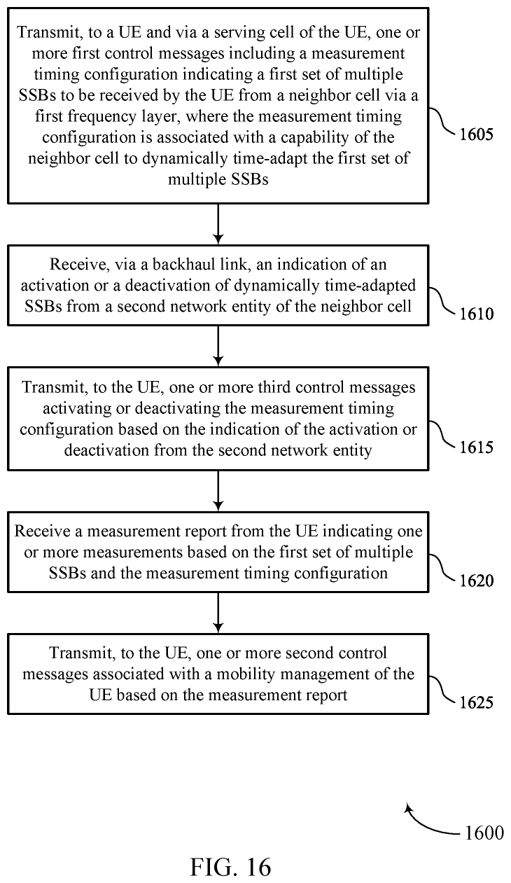

FIG. 16 shows a flowchart illustrating a method 1600 that supports measurement configuration for on-demand SSB and time-domain SSB adaptation in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE and via a serving cell of the UE, one or more first control messages including a measurement timing configuration indicating a first set of multiple SSBs to be received by the UE from a neighbor cell via a first frequency layer, where the measurement timing configuration is associated with a capability of the neighbor cell to dynamically time-adapt the first set of multiple SSBs. The operations of 1605 may be performed in accordance with examples as disclosed herein. In some examples, aspects of the operations of 1605 may be performed by a measurement timing configuration manager 1125 as described with reference to FIG. 11.

At 1610, the method may include receiving, via a backhaul link, an indication of an activation or a deactivation of dynamically time-adapted SSBs from a second network entity of the neighbor cell. The operations of 1610 may be performed in accordance with examples as disclosed herein. In some examples, aspects of the operations of 1610 may be performed by an activation manager 1140 as described with reference to FIG. 11.

At 1615, the method may include transmitting, to the UE, one or more third control messages activating or deactivating the measurement timing configuration based on the indication of the activation or deactivation from the second network entity. The operations of 1615 may be performed in accordance with examples as disclosed herein. In some examples, aspects of the operations of 1615 may be performed by an activation manager 1140 as described with reference to FIG. 11.

At 1620, the method may include receiving a measurement report from the UE indicating one or more measurements based on the first set of multiple SSBs and the measurement timing configuration. The operations of 1620 may be performed in accordance with examples as disclosed herein. In some examples, aspects of the operations of 1620 may be performed by a measurement report manager 1130 as described with reference to FIG. 11.

At 1625, the method may include transmitting, to the UE, one or more second control messages associated with a mobility management of the UE based on the measurement report. The operations of 1625 may be performed in accordance with examples as disclosed herein. In some examples, aspects of the operations of 1625 may be performed by a mobility management manager 1135 as described with reference to FIG. 11.

The following provides an overview of aspects of the present disclosure:

Aspect 1: A method for wireless communications at a UE, comprising: receiving, from a first network entity associated with a serving cell of the UE, one or more first control messages comprising a measurement timing configuration indicating a first plurality of SSBs to be received by the UE from a neighbor cell via a first frequency layer, wherein the measurement timing configuration is associated with a capability of the neighbor cell to dynamically time-adapt the first plurality of SSBs; and monitoring for the first plurality of SSBs in accordance with the measurement timing configuration.

Aspect 2: The method of aspect 1, further comprising: receiving one or more second control messages activating or deactivating the measurement timing configuration based at least in part on the first plurality of SSBs being dynamically time-adapted, wherein monitoring for the first plurality of SSBs is in accordance with the activation or deactivation of the measurement timing configuration.

Aspect 3: The method of aspect 2, wherein the one or more second control messages comprise MAC-CE messages or DCI messages.

Aspect 4: The method of any of aspects 1 through 3, further comprising: deactivating the measurement timing configuration based at least in part on a deactivation timer at the UE or on an expiration of a threshold duration of time.

Aspect 5: The method of any of aspects 1 through 4, wherein the one or more first control messages further comprise a second measurement timing configuration indicating a second plurality of SSBs to be received by the UE via the first frequency layer.

Aspect 6: The method of aspect 5, wherein the second measurement timing configuration pertains to non-dynamically time-adapted SSBs, and the second plurality of SSBs are the non-dynamically time-adapted SSBs.

Aspect 7: The method of any of aspects 5 through 6, further comprising: receiving a first SSB of the first plurality of SSBs according to a first power level, a first beam width, or both; and receiving a second SSB of the second plurality of SSBs according to a second power level, a second beam width, or both.

Aspect 8: The method of any of aspects 1 through 7, wherein the measurement timing configuration comprises a first periodicity associated with a first SSB type and a second periodicity associated with a second SSB type, the first SSB type comprising dynamically time-adapted SSB and the second SSB type comprising a non-dynamically time-adapted SSB.

Aspect 9: The method of aspect 8, further comprising: receiving one or more second control messages modifying a period of the first periodicity associated with the first SSB type, wherein the one or more second control messages comprise MAC-CE messages or DCI messages.

Aspect 10: The method of any of aspects 1 through 9, further comprising: performing a measurement procedure on the first plurality of SSBs based at least in part on a measurement state of the UE, wherein the measurement procedure comprises one of measuring the first plurality of SSBs or refraining from measuring the first plurality of SSBs.

Aspect 11: The method of aspect 10, wherein the measurement procedure comprises refraining from measuring the first plurality of SSBs, the method comprising: refraining from measuring the first plurality of SSBs based at least in part on a RRM measurement state at the UE.

Aspect 12: The method of any of aspects 10 through 11, wherein the measurement procedure comprises measuring the first plurality of SSBs, the method comprising: measuring the first plurality of SSBs based at least in part on satisfaction of a threshold level of mobility, satisfaction of a threshold signal quality, or both.

Aspect 13: The method of any of aspects 1 through 12, wherein the measurement timing configuration further indicates a plurality of neighbor cells comprising at least the first neighbor cell, wherein the monitoring comprises: monitoring for the first plurality of SSBs from the plurality of neighbor cells in accordance with the measurement timing configuration indicating the plurality of neighbor cells.

Aspect 14: A method for wireless communications at a network entity, comprising: transmitting, to a UE and via a serving cell of the UE, one or more first control messages comprising a measurement timing configuration indicating a first plurality of SSBs to be received by the UE from a neighbor cell via a first frequency layer, wherein the measurement timing configuration is associated with a capability of the neighbor cell to dynamically time-adapt the first plurality of SSBs; receiving a measurement report from the UE indicating one or more measurements based at least in part on the first plurality of SSBs and the measurement timing configuration; and transmitting, to the UE, one or more second control messages associated with a mobility management of the UE based at least in part on the measurement report.

Aspect 15: The method of aspect 14, further comprising: receiving, via a backhaul link, an indication of an activation or a deactivation of dynamically time-adapted SSBs from a second network entity of the neighbor cell; and transmitting, to the UE, one or more third control messages activating or deactivating the measurement timing configuration based at least in part on the indication of the activation or deactivation from the second network entity.

Aspect 16: The method of aspect 15, wherein the one or more third control messages comprise MAC-CE messages or DCI messages.

Aspect 17: The method of any of aspects 14 through 16, wherein the one or more first control messages further comprise a second measurement timing configuration indicating a second plurality of SSBs to be received by the UE via the first frequency layer.

Aspect 18: The method of aspect 17, wherein the second measurement timing configuration pertains to non-dynamically time-adapted SSBs, and the second plurality of SSBs are the non-dynamically time-adapted SSBs.

Aspect 19: The method of any of aspects 14 through 18, wherein the measurement timing configuration comprises a first periodicity associated with a first SSB type and a second periodicity associated with a second SSB type, the second SSB type comprising a dynamically time-adapted SSB.

Aspect 20: The method of aspect 19, further comprising: transmitting one or more third control messages modifying a period of the first periodicity associated with the first SSB type, wherein the one or more third control messages comprise MAC-CE messages or DCI messages.

Aspect 21: A UE for wireless communications, comprising one or more memories storing processor-executable code, and one or more processors coupled with the one or more memories and individually or collectively operable to execute the code to cause the UE to perform a method of any of aspects 1 through 13.

Aspect 22: A UE for wireless communications, comprising at least one means for performing a method of any of aspects 1 through 13.

Aspect 23: A non-transitory computer-readable medium storing code for wireless communications, the code comprising instructions executable by one or more processors to perform a method of any of aspects 1 through 13.

Aspect 24: A network entity for wireless communications, comprising one or more memories storing processor-executable code, and one or more processors coupled with the one or more memories and individually or collectively operable to execute the code to cause the network entity to perform a method of any of aspects 14 through 20.

Aspect 25: A network entity for wireless communications, comprising at least one means for performing a method of any of aspects 14 through 20.

Aspect 26: A non-transitory computer-readable medium storing code for wireless communications, the code comprising instructions executable by one or more processors to perform a method of any of aspects 14 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a first network entity associated with a serving cell of the UE, one or more first control messages comprising a measurement timing configuration indicating a first plurality of synchronization signal blocks (SSBs) to be received by the UE from a neighbor cell via a first frequency layer, wherein the measurement timing configuration is associated with a capability of the neighbor cell to dynamically time-adapt the first plurality of SSBs; and
monitor for the first plurality of SSBs in accordance with the measurement timing configuration.

2. The UE of claim 1, wherein the one or more processors are individually or collectively further operable to execute the code to cause the UE to:
receive one or more second control messages activating or deactivating the measurement timing configuration based at least in part on the first plurality of SSBs being dynamically time-adapted, wherein monitoring for the first plurality of SSBs is in accordance with the activation or deactivation of the measurement timing configuration.

3. The UE of claim 2, wherein the one or more second control messages comprise medium access control (MAC)-control element (CE) messages or downlink control information (DCI) messages.

4. The UE of claim 1, wherein the one or more processors are individually or collectively further operable to execute the code to cause the UE to:
deactivate the measurement timing configuration based at least in part on a deactivation timer at the UE or on an expiration of a threshold duration of time.

5. The UE of claim 1, wherein the one or more first control messages further comprise a second measurement timing configuration indicating a second plurality of SSBs to be received by the UE via the first frequency layer.

6. The UE of claim 5, wherein the second measurement timing configuration pertains to non-dynamically time-adapted SSBs, and the second plurality of SSBs are the non-dynamically time-adapted SSBs.

7. The UE of claim 5, wherein the one or more processors are individually or collectively further operable to execute the code to cause the UE to:
receive a first SSB of the first plurality of SSBs according to a first power level, a first beam width, or both; and
receive a second SSB of the second plurality of SSBs according to a second power level, a second beam width, or both.

8. The UE of claim 1, wherein the measurement timing configuration comprises a first periodicity associated with a first SSB type and a second periodicity associated with a second SSB type, the first SSB type comprising dynamically time-adapted SSB and the second SSB type comprising a non-dynamically time-adapted SSB.

9. The UE of claim 8, wherein the one or more processors are individually or collectively further operable to execute the code to cause the UE to:
receive one or more second control messages modifying a period of the first periodicity associated with the first SSB type, wherein the one or more second control messages comprise medium access control (MAC)-control element (CE) messages or downlink control information (DCI) messages.

10. The UE of claim 1, wherein the one or more processors are individually or collectively further operable to execute the code to cause the UE to:
perform a measurement procedure on the first plurality of SSBs based at least in part on a measurement state of the UE, wherein the measurement procedure comprises one of measuring the first plurality of SSBs or refraining from measuring the first plurality of SSBs.

11. The UE of claim 10, wherein, to perform the measurement procedure, the one or more processors are individually or collectively operable to execute the code to cause the UE to:
refrain from measuring the first plurality of SSBs based at least in part on a radio resource management (RRM) measurement state at the UE.

12. The UE of claim 10, wherein, to perform the measurement procedure, the one or more processors are individually or collectively operable to execute the code to cause the UE to:
measure the first plurality of SSBs based at least in part on satisfaction of a threshold level of mobility, satisfaction of a threshold signal quality, or both.

13. The UE of claim 1, wherein, to monitor for the first plurality of SSBs, the one or more processors are individually or collectively operable to execute the code to cause the UE to:
monitor for the first plurality of SSBs from a plurality of neighbor cells in accordance with the measurement timing configuration indicating the plurality of neighbor cells.

14. A method for wireless communications at a user equipment (UE), comprising:
receiving, from a first network entity associated with a serving cell of the UE, one or more first control messages comprising a measurement timing configuration indicating a first plurality of synchronization signal blocks (SSBs) to be received by the UE from a neighbor cell via a first frequency layer, wherein the measurement timing configuration is associated with a capability of the neighbor cell to dynamically time-adapt the first plurality of SSBs; and
monitoring for the first plurality of SSBs in accordance with the measurement timing configuration.

15. The method of claim 14, further comprising:
receiving one or more second control messages activating or deactivating the measurement timing configuration based at least in part on the first plurality of SSBs being dynamically time-adapted, wherein monitoring for the first plurality of SSBs is in accordance with the activation or deactivation of the measurement timing configuration.

16. The method of claim 15, wherein the one or more second control messages comprise medium access control (MAC)-control element (CE) messages or downlink control information (DCI) messages.

17. The method of claim 14, further comprising:
deactivating the measurement timing configuration based at least in part on a deactivation timer at the UE or on an expiration of a threshold duration of time.

18. A non-transitory computer-readable medium storing code for wireless communications, the code comprising instructions executable by one or more processors to:
receive, from a first network entity associated with a serving cell of a user equipment (UE), one or more first control messages comprising a measurement timing configuration indicating a first plurality of synchronization signal blocks (SSBs) to be received by the UE from a neighbor cell via a first frequency layer, wherein the measurement timing configuration is associated with a capability of the neighbor cell to dynamically time-adapt the first plurality of SSBs; and
monitor for the first plurality of SSBs in accordance with the measurement timing configuration.

19. The non-transitory computer-readable medium of claim 18, wherein the one or more first control messages further comprise a second measurement timing configuration indicating a second plurality of SSBs to be received by the UE via the first frequency layer.

20. The non-transitory computer-readable medium of claim 19, wherein the second measurement timing configuration pertains to non-dynamically time-adapted SSBs, and the second plurality of SSBs are the non-dynamically time-adapted SSBs.
